(19) United States
(12) Patent Application Publication
(10) Pub. No.: US 2014/0136709 A1
(43) Pub. Date: May 15, 2014

(54) System and Method for Resource Management in a Wireless Network

(71) Applicant: RESEARCH IN MOTION LIMITED, Waterloo (CA)

(72) Inventors: Chen-Ho Chin, Kent (GB); Richard Burbidge, Hook (GB); Stefano Faccin, San Francisco, CA (US); Ozgur Ekici, Escondido, CA (US)

(73) Assignee: Research In Motion Limited, Waterloo (CA)

(21) Appl. No.: 13/678,150

(22) Filed: Nov. 15, 2012

(51) Int. Cl. H04W 72/04

(52) U.S. Cl. CPC H04W 72/04
USPC 709/226

(57) ABSTRACT

A network node for providing resource management in a wireless network based on indicated application. The network mode is configured to receive a service request message transmitted by a user equipment, the service request message comprising an application identifier associated with a mobile application executable on the user equipment and a request for network resources to be allocated to the mobile application. The network node is also configured to determine whether the network is capable of handling the service request based at least partly upon the application identifier. In response to the determination, the network node transmits to the user equipment a response message indicating whether the network node accepts the request for network resources to be allocated to the mobile application.

### TECHNICAL FIELD

The present application relates generally to wireless communication and, more specifically, to techniques for controlling congestion in a wireless network caused by user applications executing on a mobile device.

### BACKGROUND

Technical groups, such as the 3rd Generation Partnership Project (3GPP) SA1 working group, have defined the requirements for the support of overload control mechanisms. Mechanisms will be provided to allow the network and user equipment (UE) to detect abnormally high data patterns and to provide countermeasures to protect the network and subscribers from data surges that are caused by poor design or bad implementation of, for example, mobile data applications. For example, 3GPP has been designing mechanisms for the support of overload control at the network access stratum (NAS) level, primarily at the Evolved Packet System (EPS) mobility management (EMM) level and the EPS session management (ESM) level. Technical specifications, such as 3GPP TS 23.401, provide details regarding congestions and resource control on services. Similarly, 3GPP TS 23.060 provides similar details regarding congestions and resource control on services, thereby extending what has been designed for EPS to Global System for Mobile communications (GSM)/Enhanced Data rates for GSM Evolution (EDGE) Radio Access Network (GERAN) and Universal Mobile Telecommunications System (UMTS) Terrestrial Radio Access Network (UTRAN).

However, there are number of problems with current resource management and congestion control mechanisms. A first problem involves the handling of resource management and treating resource requests during congestion. There are usage scenarios that the current defined mechanisms do not sufficiently cover. In one usage scenario, a UE/smart phone has a large number of applications and different applications have different data usage patterns. Some applications are very “chatty” and generate a lot of exchanges of small amounts of data. Other applications exchange data continuously and for different durations (e.g., a streaming application).

In another usage scenario, some applications do not use dedicated bearers, but rather use just default bearers for user plane traffic. Existing Quality of Service (QoS) control mechanisms may not be sufficient to block or limit such applications. For applications that use specific QoS, dedicated bearers are normally allocated to the device for the required QoS. However, unless a specific QoS is needed, applications typically use just the default bearer provided at the establishment of a Packet Data Network (PDN) connection for user plane traffic. Default bearers typically have “best effort” QoS control. Because applications typically just use the default bearer, it becomes difficult to control which applications misuse the default bearer. In other words, per-radio bearer QoS control does not provide sufficient granularity in the control of resources.

A second problem involves the lack of selective user plane bearer establishment. In current specifications, when user plane radio bearers are established, one of two things may happen; 1) all the user plane radio bearers for all the packet data contexts may be established, or 2) alternatively, user plane radio bearers are established only for a subset of the packet data contexts, and the UE may locally release the packet data context that did not get assigned a user plane radio bearer. In short, there is no selective user plane radio bearer establishment.

A third problem involves limiting access for selective applications in times of congestion. Certain applications or services may cause congestion to the network, and the network may want temporarily to stop such applications from getting access. This may be needed not only for new resource requests from UEs, but also for devices already connected to the network that are running application or services that the network needs to block. In short, only some, not all, applications may cause concern, and only those applications need to be addressed.

However, identifying each and every application used by mobile devices is impractical. Many thousands of applications may be available for use by the UE. Although each of these thousands of applications can be uniquely named or identified, identifying UE applications by signaling to and from the network via a protocol exchange over an open specification interface is a formidable challenge, if not impractical.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a wireless network according to an embodiment of the disclosure.

FIG. 2 illustrates a user equipment that executes mobile applications according to an embodiment of the present disclosure.

FIG. 3 is a high-level flow diagram illustrating service request processing according to an embodiment of the present disclosure.

FIG. 4 illustrates service request processing involving a mobility management element (MME) according to an embodiment of the present disclosure.

FIG. 5 illustrates service request processing involving a radio network controller (RNC) and an associated eNodeB (eNB) according to an embodiment of the present disclosure.

### DETAILED DESCRIPTION

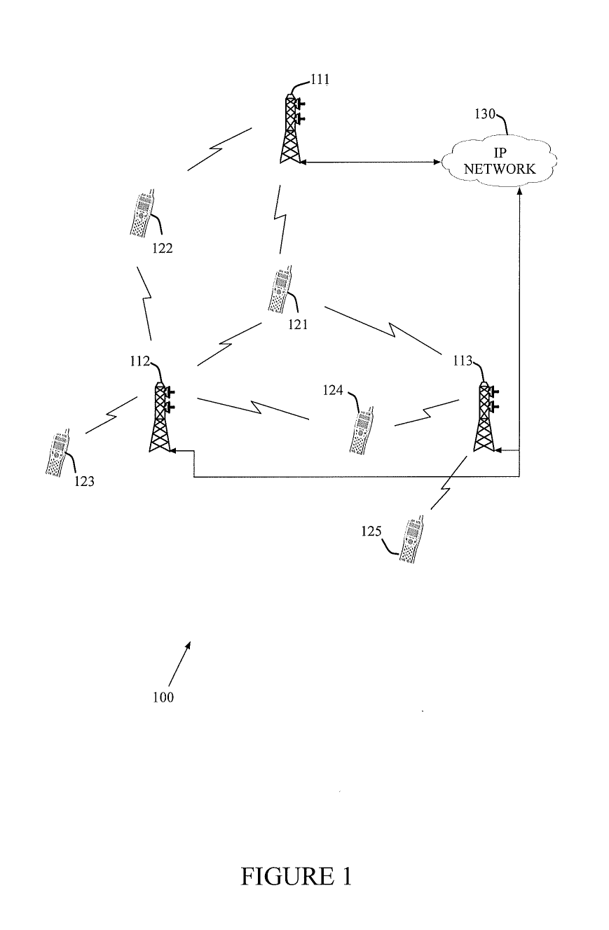

FIGS. 1 through 5, discussed herein, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless user equipment or wireless system.

The present disclosure hereby incorporates by reference the current (as of the filing date of this document) and all previous versions of the following technical specifications (TS) and technical reports, as if fully set forth herein: 1) 3GPP TS 23.060; 2) 3GPP TS 23.401; 3) 3GPP TS 23.402; 4) 3GPP TR 23.855; 5) 3GPP TS 24.008; and 6) 3GPP TS 24.301.

The present disclosure is applicable to a mobile device (e.g., a UE or mobile station) operating in many different types of network including, but not limited to: i) an Evolved UTRAN (E-UTRAN) radio access network associated with an Evolved Packet Core (EPC) core network; ii) a UTRAN radio access network associated with a General Packet Radio Services (GPRS) core network; and iii) a GERAN radio access network associated with a GPRS core network.

These present disclosure may use the following generic terminology which may apply to any of the exemplary networks listed above:

User Plane Radio Bearers—

In the case of E-UTRAN, this term corresponds to data radio bearers (DRBs) over the radio interface and evolved radio access bearers (E-RABs) over the S1u interface between the E-UTRAN and the core network. In the case of UTRAN, this term corresponds to radio bearers and RABs over the radio interface and RABs over the Iu interface between the UTRAN and the core network.

Packet Data Context—

In the case of an Evolved Packet Core (EPC) network, this term corresponds to an EPS Bearer Context, and in the case of a GPRS core network, this corresponds to a Packet Data Protocol (PDP) Context.

As used herein, the term “user equipment” (UE) may refer to a “mobile station” (MS) or “mobile device”, which can include electronic devices, such as fixed and mobile telephones, personal digital assistants, handheld or laptop computers, smartphones, printers, fax machines, televisions, set top boxes, and other video display devices, home audio equipment and other home entertainment systems, home monitoring and control systems (e.g., home monitoring, alarm systems and climate control systems), enhanced home appliances such as computerized refrigerators and similar devices that have network communications capabilities. In some configurations, UE may refer to a wireless device. The terms may also refer to devices that have similar capabilities but that are not readily transportable, such as desktop computers, set-top boxes, TV, IPTV, or network nodes. The terms “application-based service requests”, “application-based resource control”, “application-based resource request”, and “application-based resource management” are interchangeable. The term network may indicate one or more of a Serving GPRS Support Node (SGSN), MME, eNB, RNC, Gateway GPRS Support Node (GGSN) or packet data network gateway (PDN GW).

Resource Request in IDLE and in Connected Mode—

As is well known, a UE may request resources when it is IDLE (i.e., not having a connection with the network (NW) and not having any user plane resources). This is typically termed as a UE moving from “IDLE to ACTIVE” mode. However, a UE may still request additional resources or modification of existing resources when the UE is in ACTIVE mode and has assigned user plane resources.

FIG. 1 illustrates a wireless network 100 according to an embodiment of the present disclosure. Wireless network 100 includes base station (BS) 111, BS 112, and BS 113. BS 111, BS 112 and BS 113 may communicate with each other via wireless links or by a wireline backbone network. By way of example, in FIG. 1, each of base stations 111-113 is configured to communicate with other base stations using Internet protocol (IP) network 130. Each of base stations 111-113 may also be configured to communicate with a conventional circuit-switched telephone network (not shown), either directly or by means of network 130.

BS 111 provides wireless broadband access to network 130 to a first plurality of user equipments (UEs) within a coverage area of BS 111. The first plurality of UEs includes user equipment (UE) 121 and UE 122, among others. BS 112 provides wireless broadband access to network 130 to a second plurality of UEs within a coverage area of BS 112. The second plurality of UEs includes UE 121, UE 122, UE 123, and UE 124, among others. BS 113 provides wireless broadband access to network 130 to a third plurality of UEs within a coverage area of BS 113. The third plurality of UEs includes UE 121, UE 124, and UE 125, among others. It is noted that UE 121 is able to access all three of base stations 111-113, whereas UE 125 is only able to access BS 113 and UE 123 is only able to access BS 112. UE 122 and UE 124 can each access two base stations.

Each of base stations 111-113 may provide different levels of service to UEs 121-125 according to priority levels (common and/or dedicated) associated with each UE. UEs 121-125 may use the broadband access to network 130 to access voice, data, video, video teleconferencing, and/or other broadband services. Each one of UEs 121-125 may be any of a number of types of wireless devices, including a wireless-enabled laptop computer, a personal data assistant, a notebook, a mobile phone, a tablet, or another wireless-enabled device.

It is noted that the term “base station” may be commonly used in some types of networks, such as CDMA2000 systems or some 3GPP systems. But “base station” is not universally used in all types of radio access technology (RAT). In some types of networks, the term “base station” may be replaced by “eNodeB”, or “eNB”, or “Node B” or “access point”. For the purposes of simplicity and consistency, the term “base station” is used in this disclosure document, and in the claims in particular, to refer to the network infrastructure device that provides wireless access to user equipment. The term “base station” may also include a combination of network infrastructure devices (for example, Node B and RNC) that provides wireless access to user equipment.

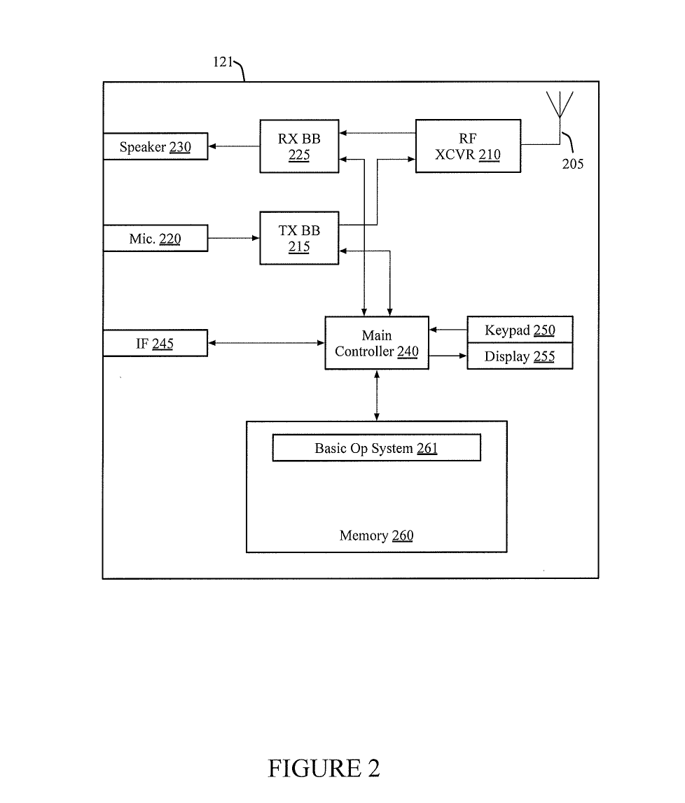

FIG. 2 illustrates a user equipment (UE) 121, which executes mobile applications according to the principles of the present disclosure. UE 121 comprises at least one antenna 205, radio frequency (RF) transceiver (XCVR) 210, transmitter baseband (TX BB) processing circuitry 215, microphone 220, and receiver baseband (RX BB) processing circuitry 225. UE 121 also comprises speaker 230, main controller 240, input/output (I/O) interface (IF) 245, keypad 250, display 255, and memory 260. Memory 260 stores basic operating system (OS) program 261.

Radio frequency transceiver 210 receives from antenna 205 an incoming RF signal transmitted by a base station of wireless network 100. Radio frequency transceiver 210 comprises receiver circuitry configured to operate in cells associated with one or more types of radio access technology (RAT) networks (e.g., GSM, GERAN, UTRAN, E-UTRAN, etc.). Radio frequency transceiver 210 down-converts the incoming RF signal to produce an intermediate frequency (IF) or a baseband signal. The IF or baseband signal is sent to RX BB processing circuitry 225, which may produce a processed baseband signal by, for example, filtering and digitizing the received baseband or IF signal, additional filtering, and, if necessary, demodulation and/or decoding. Receiver baseband (RX BB) processing circuitry 225 transmits the processed baseband signal to speaker 230 (i.e., voice data) or to main controller 240 for further processing (e.g., web browsing).

Transmitter baseband (TX BB) processing circuitry 215 may receive analog or digital voice data from microphone 220 or other outgoing baseband data (e.g., web data, e-mail, interactive video game data) from main controller 240. TX BB processing circuitry 215 may encode, modulate, multiplex, and/or digitize the outgoing baseband data to produce a processed baseband or IF signal. Radio frequency transceiver 210 receives the outgoing processed baseband or IF signal from TX BB processing circuitry 215. Radio frequency transceiver 210 up-converts the baseband or IF signal to a radio frequency (RF) signal that is transmitted via antenna 205.

Main controller 240 may comprise any device, system or part thereof that controls at least one operation. Such a device may be implemented in hardware, firmware or software, or some combination of at least two of the same. In an advantageous embodiment, main controller 240 may be a microprocessor or a microcontroller. Memory 260 is coupled to main controller 240. Part of memory 260 may comprise a random access memory (RAM), and another part of memory 260 may comprise a non-volatile memory, such as Flash memory.

Main controller 240 executes basic operating system (OS) program 261 stored in memory 260 in order to control the overall operation of UE 121. In one such operation, main controller 240 controls the reception of forward channel signals and the transmission of reverse channel signals by radio frequency transceiver 210, RX BB processing circuitry 225, and TX BB processing circuitry 215, in accordance with well-known principles.

Main controller 240 is capable of executing other processes and programs resident in memory 260. Main controller 240 can move data into or out of memory 260, as required by an executing process. Main controller 240 is also coupled to I/O interface 245. I/O interface 245 provides UE 121 with the ability to connect to other devices, such as laptop computers and handheld computers. I/O interface 245 is the communication path between these accessories and main controller 240. Main controller 240 may also be coupled to an input device, such as keypad 250, and display 255. The operator of UE 121 uses keypad 250 to enter data into UE 121. Display 255 may be a liquid crystal display capable of rendering text and/or at least limited graphics from web sites. Other examples may use other types of displays (or none). Display 255 may include a touch screen input device that may be used in conjunction with, or in place of, keypad 250.

More particularly, main controller 240 executes basic OS program 261 in order to send a service request (SR) associated with the need to transmit user data corresponding to mobile applications to network nodes. Thus, in the descriptions that follow, the operations of UE 121 related to requesting radio bearers, transmitting AppIdentifiers to network nodes, and transmitting and receiving traffic associated with a mobile application are performed by main controller 240 under the control of basic OS program 261.

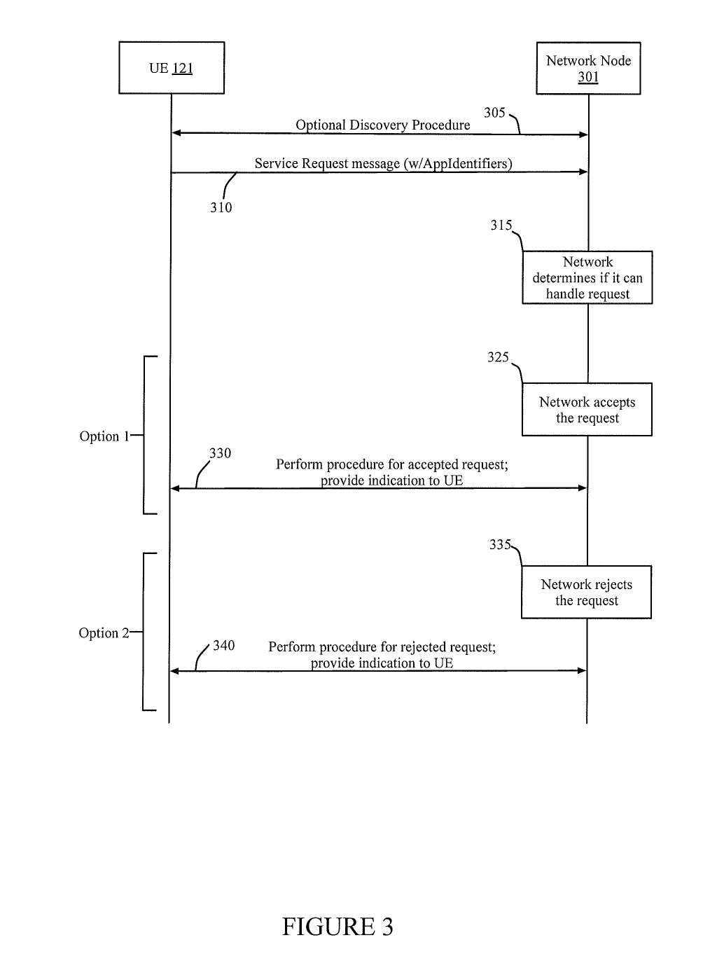

FIG. 3 is a high-level flow diagram illustrating service request processing according to an embodiment of the present disclosure. Initially, UE 121 may perform a discovery procedure with network node 301 to determine if wireless network 100 supports application-based resource management techniques according to the present disclosure (305). Network node 301 may be any one of a number of different network entities, depending on the network architecture. The optional discovery procedure may include UE 121 sending to network node 301 an indication (or flag or identifier) that indicates to network 100 that UE 121 supports application-based resource management. Upon receiving the indication from UE 121, network 100 may send a message to UE 121 containing an indication (or flag, identifier) that identifies that network 100 supports application-based resource management. When user radio bearer resources are required, UE 121 transmits a Service Request (SR) message, which includes one or more AppIdentifier values that identify or indicate to network 100 one or more mobile applications associated with UE 121 for the purpose of resource management control (310).

Network node (NN) 301 then determines if NN 301 is capable of handling or satisfying the Service Request for the identified applications (315). NN 301 then responds to UE 121 and indicates which applications are subject to control according to two options. In a first option (Option 1), network 100 (in this particular embodiment, NN 301) accepts the Service Request (325) and proceeds with procedures for handling the accepted Service Request and may transmit to UE 121 indications of which applications from the request have been accepted or rejected (330). If the service request is rejected, include one or more backoff timers to indicate to UE 121 to not attempt further requests for the indicated application(s) for the duration of the timers. One timer may be used for all applications that were indicated in the original service request. Alternatively, an individual timer may be used for each individual application indicated in the service request. In a second option, network 100 rejects the Service Request (335) and proceeds with the procedures for handling the rejected Service Request and may transmit to UE 121 indications for which applications the request has been rejected (340). As before, may include one or more backoff timers to indicate to UE 121 to not attempt further requests for the indicated application(s) for the duration of the timers.

Network 100 (in this particular embodiment, NN 301) may provide to UE 121 a watch list of identified applications. The watch list enables the network 100 to inform UE 121 of the applications UE 121 should report on or provide an indication of, and indicates that to UE 121 by sending a message to UE 121. When UE 121 gets this message, UE 121 keeps this watch list. Thereafter, UE 121 indicates to network 100 whenever any of the applications on the watch list identified by network 100 to be tracked, requests user plane resources. UE 121 may store the watch list in memory 260.

The present disclosure describes an optional discovery procedure that discovers or determines if the network supports application-based resource management. The present disclosure also describes techniques or methods by which the network provides a watch list of applications to be monitored by the user equipment. In a particular embodiment, the user equipment first signals to the network a list of mobile applications residing in the user equipment. The network responds by indicating a watch list of applications to be monitored by the user equipment and also indicates what actions the user equipment should perform if an application on the watch list requests resources. In another embodiment, the network transmits the watch list to the user equipment independent of whether or not the user equipment first signals a list of mobile applications residing on the user equipment (i.e., even if the user equipment has not signaled a list of applications to the network). The present disclosure describes methods for classifying applications. The classification of applications provides a means by which the network indicates actions to be taken with respect to the watch list of applications. In sum, the user equipment ends up with a watch list of applications and indications of actions to be taken for those applications (i.e., a list of applications the user equipment watches out for or monitors or reports on or not allow to use allocated user plane radio bearers).

The present disclosure describes a mechanism for application-based resource management wherein a UE that needs to establish or re-establish user plane bearers to transport user traffic may provide to the network in a request message an indication of the type of application or service being requested. Hereinafter, the disclosure will refer to applications, but the indications could also relate to services. The network then decides whether to allocate resources or reject the request based on the indication provided by the UE and other information known to the network (e.g., availability of resources, load conditions in the network, and the like) or provided also by the UE. The following are common basic concepts of the present disclosure.

Classification of Applications

Applications or services are identified by an AppIdentifier value. In the context of this disclosure, the term AppIdentifier is referred to in generic terms, but may differ from what is defined in some existing standards for identification of applications (e.g., in Data Identification in Access Network Discovery and Selection Function (DIDA), see 3GPP TR 23.855). In the context of this disclosure, there can be, for instance, one or more of the following: 1) Application Identity, 2) Application Type, 3) Application Characteristics, 4) Service Identity and 5) Application Index.

The Application Identity (AppID) value is an identifier that is specific to a mobile platform or an operating system (OS). The AppID value can be provided to device when the application is installed.

The Application Type (AppType) value is a description of the type of behavior of an application, such as “instant messaging”, “non-real-time messaging”, “device browsing”, “remote browsing”, “audio streaming”, “video streaming”, “high priority signaling” (e.g., SIP signaling), low priority signaling, e-mail, and the like. Additional or different values identifying application types may be be defined if needed. An AppType may be associated with a specific application by a standard or may be associated with applications by, for example, the application market selling them, or may be defined for an application in a platform-specific manner (e.g., Blackberry AppWorld defines them for BlackBerry or PlayBook devices). The AppType may be provided to the device when the application is installed. The AppType may also be defined by an operator, or by the application developers, or by the application market when the application is submitted to the application market.

The Application Characteristics value is a set of characteristic describing an application. Such characteristics may include, for example, one or more of: a) priority of the application; and b) QoS associated with the application (e.g., any of the QoS parameters associated with bearers such as delay tolerance, Guaranteed Bit Rate (GBR), Maximum Bit Rate (MBR), QoS Class Identifier (QCI), and the like).

The Service Identity value is an identifier used by applications or services to identify the specific service requiring or using the transport resources or requesting a connection and/or to identify the end-point of a service. The Service Identity specifies the specific service, and differs from the AppID and AppType since different applications (e.g., with different AppIDs) may be used to provide the same service. Therefore, different AppIDs may correspond to the same Service Identity. As an example, the device may have two different browsers installed, both providing the same type of service. However, the two browser applications may have different AppIDs, even though they have the same Service Identity. Conversely, for example, the same AppType can have different Service Identity values. For instance, news service and advertisement (e.g., film flyers) can be provided through video streaming. While both the news service and advertisement can be of same AppType (i.e., video streaming), their Service Identities would be different.

A list of Application Index values may be defined to identify applications since Application Identity and/or Application Type may be a long string. The Application Index value may be an integer number, and may refer to the position of the Application Identity and/or Application Type within a list of Application Identities and/or Applications Types passed between the UE and the network. Once the list is known to both the UE and to the network then subsequent communication between the UE and the network may refer to the Application Index as a shorter alternative to referring to the full Application Identity and/or Application Type. Instead of the UE providing Application Identity and Application Type, the UE may instead provide in a request message the Application Index value that corresponds to the Application Identity and/or Application Type.

In some embodiments, it is not necessary to define an AppIdentifier for each application. There may be sets of applications that have a common actual behavior or common expected behavior that may be identified by the same AppIdentifier. This allows for a lower number of AppIdentifier values to be defined for each platform or operating system.

Network node 301 (e.g., MME or SGSN) may be made aware (e.g., by configuration from the operator) of the values of AppIdentifier. In one example, the MME or Serving GPRS Support Node (SGSN) may have a list of AppIdentifiers associated with a specific mobile platform or operating system. In one example, the UE provides to the network node an identifier of the platform or operating system in a message (e.g., in EPS Mobility Management (EMM) or GPRS Mobility Management (GMM)/Session Management (SM) or EPS Session Management (ESM) procedures) or in a variety of messages (e.g., attach procedure, Tracking Area Update (TAU) procedure, Routing Area Update (RAU) procedures, etc.). The UE may provide to the SGSN/MME in MM/EMM messages (e.g., attach request, routing area request, tracking area request) the manufacturer, model, DevID information element already defined for the DevInfo management object of Open Mobile Alliance Device Management (OMA DM), see for instance OMA-ERELD-DM-V1_{—}2—“Enabler Release Definition for OMA Device Management”.

Software Application Programming Interface (API)

When an application requests resources for the transport of IP traffic, the application (or service) may provide to the lower layers the AppIdentifier using an API. Alternatively, the platform or operating system may already be aware of the AppIdentifier (e.g., provided when the application is installed or configured in the device) without the need for the application to provide such information dynamically.

Binding Between Application Types And Bearers

The UE and the network may maintain a binding between AppIdentifiers and packet data contexts. The UE may create the binding when the applications request connectivity. Either the application indicates its AppIdentifier in the API request for connectivity or the AppIdentifier is stored in the UE upon installation of the application (e.g., AppWorld or iTunes or Android Marketplace provides it to the UE), and the AppIdentifier is associated with the packet data context created or used if already existing when the application requests connectivity. The bindings may be provided by the UE in requests to the network. The UE may provide an indication to the network of the AppIdentifier(s) associated with a packet data context.

Applications Related to Pending User Traffic

In the following description, applications or AppIdentifiers that are related to pending traffic are referred to as “the Active Set of AppIdentifiers”. An Active Set of Applications comprises AppIdentifiers of applications that are currently active in the device. As applications become active (or get activated) or when applications are stopped, their corresponding AppIdentifier can be added or removed from the Active Set of Applications. Various criteria may be used for adding and removing AppIdentifiers to and from the active set. For example: i) the applications that are running in the device, independent of whether they are transmitting data or not, are added to the active set and they are removed from the active set when the application is closed; ii) the applications that are generating traffic (i.e., the pending traffic to be transmitted has been generated by such application(s)) are added to the active set; iii) when a new packet data context (e.g., PDN connection) is created, an application running on the device and requiring such packet data context for data transmission is added to the active set; and iv) an application is running in the device and has previously generated data, but has not generated data in a while, then the application is removed from the active set.

An application may be considered related to pending traffic that the device needs to transmit based on a variety of implementation-dependent mechanisms. In addition, a UE may receive configuration information from the network (e.g., with the network providing a management object or configuration information to the device) regarding how and when an application should be included in the Active set of AppIdentifiers and regarding how and when the UE needs to indicate the application to the network (e.g., as soon as the application is in the Active set).

Single Service Request with Indicated Application(s)

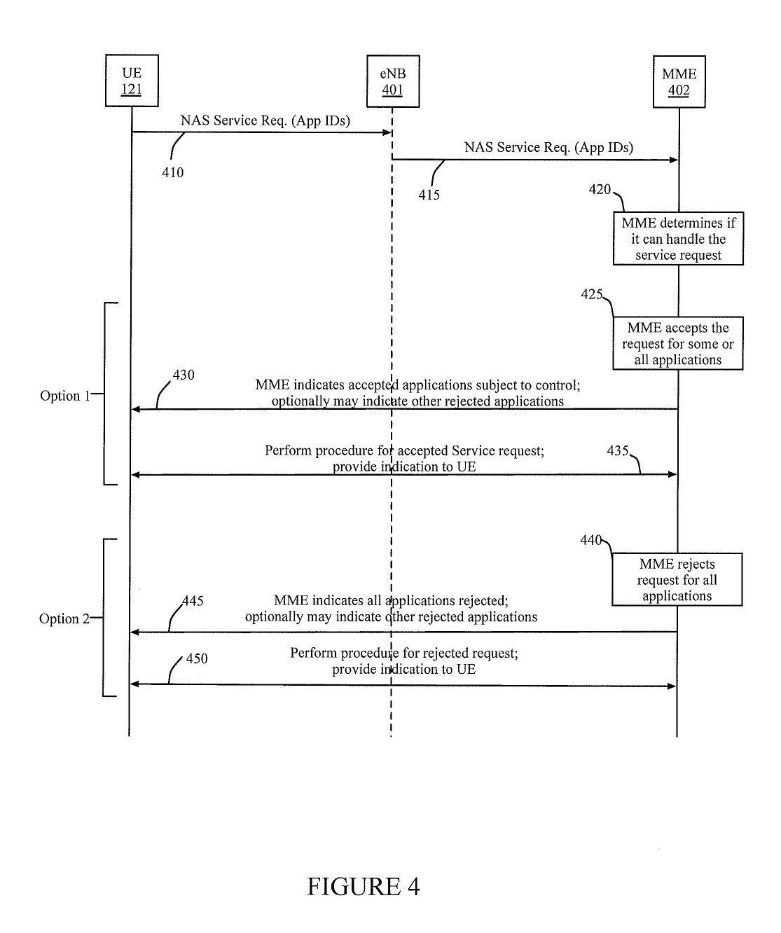

FIG. 4 illustrates service request processing involving a mobility management element (MME) according to an embodiment of the present disclosure. The service request processing in FIG. 4 applies to the non-access stratum (NAS) level and assumes that a Service Request is sent only when UE 121 does not have any user plane radio bearers assigned and the UE needs to establish user plane radio bearers because the UE has pending data. However, this is by way of example only. In other scenarios, UE 121 may already have user plane radio bearers assigned. This disclosure defines a mechanism for application-based resource management wherein a UE that needs to establish or re-establish user plane bearers to transport traffic (e.g., for one or more applications) provides to the network in a request message (e.g., a NAS Service Request) one or more indications of applications requesting service (i.e., for which the device needs to establish the user plane bearers) or indications of what applications require user plane bearers.

For the sake of simplicity and clarity, much of the following description is directed to E-UTRAN and EPC embodiment, except where noted. However, this is by way of example only and should not be construed to narrow the scope of the disclosure or the claims below. Those skilled in the art will readily understand that the teachings of the present disclosure may easily be adapted for use in other network implementations, including, for example, UTRAN/UMTS and GPRS/GERAN implementations. In FIG. 4, UE 121 transmits through eNodeB 401 (i.e., a base station) to the MME 402, a NAS Service Request containing one or more AppIdentifier value indicating one or more applications requesting service (410 and 415). Upon receiving the service request from UE 121, network 100 (in this particular embodiment, MME 402) determines if the network 100 can handle the service request and decides whether to accept or reject the request received from UE 121 based on the indication of applications provided by UE 121 and various other conditions (e.g., load conditions, non-UE-specific policies defined by the operator with respect to what services should have preference, UE-specific or subscription-specific policies based on subscription information for the UE, and the like) (420). Network 100 may reject the service request and include one or more rejection causes and may include one or more backoff timers to indicate to UE 121 to not attempt further requests for the indicated application for the duration of the timers. In an embodiment, one timer may be used for all applications that were indicated in the original service request. In other embodiments, multiple timers may be used for multiple applications, including using an individual timer for each individual application indicated in the service request.

Upon receiving a request from UE 121, network 100 may perform one of two options. In a first option (Option 1), network 100 may accept the service request for some indicated applications and reject the resource allocation for other indicated applications (425). Network 100 (e.g., MME 402) transmits an explicit or implicit indication to UE 121 indicating for which applications the service request was accepted and may further indicate the rejected applications (430). Network 100 also may include one or more backoff timers to indicate to UE 121 that for the rejected applications, to not attempt further requests for resources for those rejected applications for the duration of the timers. As noted above, there may be one timer for all the rejected applications or individual timers for each of the rejected applications. UE 121 and network 100 proceed with procedures for handling the accepted Service Request (435). Network 100 may provide additional information to UE 121 that may apply to all applications or that may be application-specific.

In a second option (Option 2), network 100 rejects the service request for all applications (440). Network 100 (e.g., MME 402) transmits an explicit or implicit indication to UE 121 indicating the service request was rejected for all applications and may further indicate other rejected applications not already indicated by the UE in the original service request (445). Network 100 also may include one or more backoff timers to indicate to UE 121 to not attempt further requests for those indicated applications for the duration of the timers. Finally, UE 121 and network 100 proceed with procedures for handling the rejected service request (450). Network 100 may provide additional information to UE 121 that may apply to all applications or that may be application-specific.

Upon receiving such additional information, UE 121 provides the information to the upper layers. In an embodiment, the upper layers provide a notification to the user of UE 121. The notifications may include: i) visual—message, icon, screen flashing, animation, picture, graphic, flashing a light-emitting diode (LED) or other light source; ii) audible indication (a beep, a ring, music, sound); iii) physical/haptic—vibration, buzz, temperature change; and iv) a combination of these indicators.

In an embodiment, the network sets up the user plane radio bearers for all Evolved Packet System (EPS) Bearer Contexts. Due to this, it could be considered that the NAS Service Request procedure has been accepted. However, the network (e.g., eNB 401 for messages exchanged at the AS level, MME 402 or the SGSN for messages exchanged at the NAS level) sends an indication (e.g., in a Service Reject message) that the network does not accept some of the indicated applications. The UE upper layers (e.g., the operating system) are responsible for ensuring that that specific application does not use the established user plane radio bearers until the UE sends a later request that is accepted or until guard timer (e.g., the backoff timer the UE receives upon rejection) expires. Other applications that were explicitly accepted or implicitly accepted (i.e., by not being explicitly rejected) would be able to use the established user plane radio bearers.

In some embodiments, the network sets up the user plane radio bearers for EPS Bearer Contexts for the indicated applications that are accepted by the network, but does not set up the user plane radio bearer for the EPS Bearer Contexts for indicated applications that are not accepted by the network. In order for the network to be able to do this, the network may be aware of the binding between applications and EPS Bearer Contexts. In particular embodiments, this binding information is provided in the Service Request message along with the application indications or provided in advance of the Service Request message by another NAS message.

Detailed Description of Single Service Request With Indicated Applications

Non-Access Stratum (NAS) Embodiments

In the following description, “request” refers in general to a message (e.g., a UE NAS message), including Service Request. In addition, it may apply to a request for bearer or resource modification message, a BEARER RESOURCE MODIFICATION REQUEST message, or a BEARER RESOURCE ALLOCATION REQUEST message.

When the UE needs to establish or re-establish user plane bearers to transport traffic (e.g., for one or more applications), the UE sends a request message (e.g., a NAS Service Request or an Access Stratum Radio Resource Control (AS RRC) Connection Request) to the network and provides an indication of the kind of traffic that will make use of the requested resources (i.e., for which the UE needs to establish the user plane bearers) identified by one or more AppIdentifier(s). In an embodiment, the UE includes in the request the AppIdentifier(s) of the application(s) that require the establishment of user plane resources. The UE expects that user plane radio bearers are assigned in order to provide transport resources for all applications or a subset of them, based on network authorization. User plane radio bearers may be allocated specifically for each application, or one user plane radio bearer may be allocated for a set of applications.

In another embodiment, the UE includes in the request the AppIdentifiers related to applications that are running on the device. In still another embodiment, the UE includes in the request the AppIdentifiers related to applications that are installed on the UE. With this information provided by the UE, the network can indicate back to the UE to limit or block transmission of data for applications that the user may activate at any time after the UE sends the request for resources.

Network Behavior Upon Receiving a Request from the UE

Upon receiving a request with AppIdentifier(s), the network (e.g., MME, SGSN, and the like) determines whether to accept or reject the service request based on the AppIdentifier(s) and a variety of conditions. The conditions may be based, for example, on one or more of load conditions, non-UE-specific policies defined by the operator with respect to what services should have preference, UE-specific or subscription-specific policies based, for example, on subscription information for the UE. If the congestion is not at the radio access level or radio network level (i.e., the request at RRC level is accepted), there may still be congestion in the core network (CN). Therefore, it is necessary to provide the CN with information to allow the CN to reject, or partially reject, or partially accept, the request. In such a reject (partial reject or partial accept), the NW may also indicate which service(s) or applications the network is rejecting.

In an additional case, upon receiving a request from the UE containing no AppIdentifier(s), the network determines whether to accept the request, partially accept the request, or reject the request based a variety of conditions. As an example, the network may decide to accept, partially accept, or reject the UE request based solely based on one or more of the load conditions in the network, even if the network does not know the set of applications in the UE. This applies, for example, to situations where the network preventively seeks to limit the UE from generating traffic for certain applications that may cause congestion in the network. Alternatively, the network may decide based on non-UE-specific policies defined by the operator regarding what services—as an example identified by AppIdentifier(s)—should have preference, or it may use UE-specific policies based, for example, on subscription information for the UE.

If the network determines that the request is to be rejected, the network returns a rejection message containing a rejection cause. In a first case, the network rejects the request and includes in the service reject message a backoff timer that applies to all the AppIdentifier(s). In a second case, the network rejects the request and includes in the service reject message a list of AppIdentifier(s), and for each listed AppIdentifier, a backoff timer is provided (i.e., multiple timers). In a third case, the network rejects the request and includes in the service reject message a list of the AppIdentifier(s) and one backoff timer that applies to all the listed AppIdentifier(s). In a fourth case, the network rejects the request and includes in the service reject message a list of AppIdentifiers that includes AppIdentifiers not already indicated by the UE. For this list of AppIdentifiers, the network includes a backoff timer for each listed AppIdentifier (i.e., multiple timers) or just one backoff timer applicable to the entire list of AppIdentifiers (i.e., one common timer). In a fifth case, the network rejects the request with a message. The message contains no backoff timer or list of AppIdentifiers. The reject cause value in the reject message may be a new reject cause value or an existing reject cause value.

If the network determines that the request can be accepted for all or some AppIdentifiers, three scenarios are possible. In a first scenario, the network proceeds with the establishment of the user plane radio bearers corresponding to all the AppIdentifier(s) for which the request has been accepted, and the provisioning and establishment of user plane radio bearers indicates implicit acceptance by the network. The network does not send any explicit NAS messages to the UE.

In a second scenario, upon accepting the request for some of the listed applications, the network may return a service accept (such as the SERVICE ACCEPT message defined in TS 24.008) to the UE in addition to triggering the eNB for the establishment of the user plane radio bearers. If the UE has included one or more AppIdentifier(s) in the service request, upon accepting the service request for some of the applications in the AppIdentifier list, the network may send a Service Accept message to the UE including a list of AppIdentifiers for which the request has not been accepted. In one case, upon receiving a service request with a list of AppIdentifier(s), upon accepting the service request for some of the applications in the AppIdentifier list, the network sends a Service Accept message to the UE including in the Service Accept message the list of AppIdentifier(s) for which the request has been accepted. In some embodiments, the network includes in the service accept message a list of the AppIdentifier(s) for which the request is not accepted and includes one backoff timer that applies to all the AppIdentifier(s). In other embodiments, the network includes in the service accept message a list of the AppIdentifier(s) for which the request is not accepted and a backoff timer for each of the listed AppIdentifier. In further embodiments, the network includes in the service accept message the list of AppIdentifier(s) for which the request has been accepted and one backoff timer that applies to all the other AppIdentifier(s) that have not been listed.

In a third scenario, the network proceeds with the establishment of the user plane radio bearers corresponding to the AppIdentifier(s) for which the request has been accepted and provides to the UE the following information by having the network node (e.g., MME, SGSN, or the like) provide such information to the radio access network (e.g., eNB, RNC, or the like), and the radio access network in turn conveys that information to the UE in AS signaling. In one case, if the UE included in the service request a list of AppIdentifier(s) and the network accepts the request only for some AppIdentifier(s), the network includes the list of AppIdentifier(s) for which the request has been accepted. In some embodiments, the network includes a list of the AppIdentifier(s) for which the request is not accepted and one backoff timer that applies to all the AppIdentifier(s) in the list. In other embodiments, the network includes a list of the AppIdentifier(s) for which the request is not accepted and a backoff timer for each AppIdentifier in the list. In further embodiments, the network includes the list of AppIdentifier(s) for which the request has been accepted and one backoff timer that applies to all the other AppIdentifier(s) that have not been listed. In general, upon accepting the service request for some of the applications identified by AppIdentifier(s) in the service request, the network sets up or triggers the establishment of user plane radio bearers only for those AppIdentifier(s) for which it has accepted the request.

UE Behavior Upon Receiving a Response from the Network

Upon receiving a Service Reject containing a list of AppIdentifier(s) for which the request has not been accepted, the UE has a number of options. If a single backoff timer is provided in the SERVICE REJECT, the UE applies the backoff timer to all applications identified in the list of AppIdentifier(s) received from the network. If a backoff timer for each identified application in the list of AppIdentifier is provided in the SERVICE REJECT, the UE applies the specific backoff timer to the specific identified application in the list of AppIdentifier. In one embodiment, the UE applies the current (up to Rel-10) ESM/SM backoff solution (i.e., congestion control) based on the AppIdentifier and the related backoff timer. This means that the ESM/EM backoff mechanism is applied at the AppIdentifier level regardless of the Access Point Name (APN). In another embodiment, the UE does not apply any backoff timers to AppIdentifier(s) that are not included in the list the UE receives from the network in the Service Reject. In particular, if the UE included in the service request a list of AppIdentifier(s) and there are AppIdentifier(s) in such list that are not included in the list of AppIdentifier(s) that the UE receives in the Service Reject, the UE does not apply any backoff timers to such AppIdentifier(s).

In a case of partial acceptance by the network (i.e., the network accepts the request for some AppIdentifiers but not for other AppIdentifiers), upon receiving a Service Accept message from the network containing a list of AppIdentifier(s) for which the request has not been accepted, the UE has two options. If the UE receives in the Service Accept a single backoff timer, the UE applies the backoff timer to all applications in the list of AppIdentifier(s) received from the network. If the UE receives in the Service Accept a backoff timer for each identified application in the list of AppIdentifier, the UE applies the specific backoff timer to the specific identified application in the list of AppIdentifier(s).

Upon receiving a Service Accept message that may contain a list of AppIdentifier(s) for which the request has been accepted and upon receiving from the lower layers an indication that user plane radio bearers were not established for some packet data contexts (or an indication from the lower layers of what user plane radio bearers were established), the Non-Access Stratum (NAS) in the UE determines which packet data contexts were not allocated user plane radio bearers and does not release the packet data contexts corresponding to the applications in the list of AppIdentifier(s) that did not receive a user plane radio bearer.

Receiving acceptance of a request by the network includes determining successful completion of the request procedure.

In one embodiment, for packet data context whose application IDs the UE did not include in the service request (SR) message and for which the network in subsequent allocation of bearers did not allocate user plane radio bearers, the UE may locally deactivate those EPC bearer contexts. But for those packet data contexts that do not get allocated user plane radio bearers but whose application IDs the UE did include in the SR message, the UE does not locally deactivate those packet data contexts. In some scenarios, the UE receiving an indication from the network that the request cannot be accepted includes receiving in the Service Accept a list of AppIdentifier(s) and corresponding backoff timer(s).

In another embodiment in which the network accepts the SR but does not send the service accept and the UE did provide one or more AppIdentifier(s) in the SR, then the UE does not release the packet data contexts corresponding to the AppIdentifier(s) that did not receive a user plane radio bearer and for which the UE has received an indication from the network that the request cannot be fully accepted (i.e., only partially accepted). This partial acceptance is indicated through the AS level signaling and passed to the NAS with the AS further indicating the assigned user plane radio bearers. In some scenarios, the UE receiving an indication from the network that the request cannot be accepted includes receiving a list of the AppIdentifier(s) and corresponding backoff timer(s).

The UE behavior when applying a backoff timer to an application is described as follows. A UE applying a backoff timer to an application includes starting a timer associated with an application identified in the list of AppIdentifiers returned by the network. While the backoff timer is running, all requests for bearer establishment or traffic transmission by applications for which the backoff timer is running will be ignored until the timer expires or is stopped. In an embodiment, starting a timer includes starting and running the timer at the NAS layer. In another embodiment, starting a timer includes passing the timer to the upper layer (e.g., the application(s)) and starting and running the timer at the upper layer.

A UE applying a backoff timer to one or more applications corresponding to an AppIdentifier includes dropping all IP packets corresponding to such applications while the backoff timer is running and the backoff timer has not expired. A UE applying a backoff timer to one or more applications corresponding to an AppIdentifier includes indicating to the upper layers or the application(s) corresponding to the AppIdentifier that traffic cannot be sent or received. The UE does this for the duration of the backoff timer corresponding to the AppIdentifier. When the backoff timer expires, the application proceeds to either use the existing user plane resources or request new user plane resources. In an embodiment, the expiration of the timer is indicated to the upper layer (e.g., in an AT command).

Details of UE Information Storage

Since the UE provides a list of AppIdentifier(s) when requesting resources, and since it is possible for the network to return a different list of AppIdentifier(s), as well as common or individual backoff timers for the listed applications, it can be seen that the UE will manage a matrix of data information. A logical solution to managing such an inter-related matrix of data is for the UE to implement a table in which specific instances of applications linked to AppIdentifier(s) are stored against backoff timers, the associated EPS bearers or user plane radio bearers, and possibly the associated APNs of the contexts for supporting these applications.

Such a table can be created in a number of ways:

Remote Configuration of the UE:

A network entity remotely configures the UE with a list of the AppIdentifier(s) to be used in the UE. The remote entity may be a network node or group of network nodes in a mobile network operator, an enterprise or a service provider. OMA DM can be the protocol method used to configure the UE (see for instance OMA-ERELD-DM-V1_{—}2—“Enabler Release Definition for OMA Device Management”) or a removable memory card in the UE (e.g., Universal Integrated Circuit Card (UICC)) with Universal Subscriber Identity Module (USIM) application can be configured with the information.

Upon Installation of an Application in the UE:

This can happen by having the user manually enter the type of application in an installation menu, or the entity or service providing the application (e.g., Blackberry AppWorld) providing the AppIdentifier(s) for the application being installed.

Upon Requests from Applications Knowing its AppIdentifier(s):

In this case, the table is populated when an application running in the UE requests resources for the transport of user plane data. In such a case, the table is dynamically modified every time applications are launched or terminated. A table created dynamically based on application requests may contain a validity timer associated with each entry. The table may contain an application identifier that can be an AppTransactionID associated with the request from the application.

An example of such a table is shown in TABLE 1.

TABLE 1
UE APPLICATION TYPES

| Specific | | | | | |
|---|---|---|---|---|---|
| Appl. | | Associated | EntryValidity | Backoff | EPS |
| Instance | AppIdentifier | APN | Timer | Timer | Bearers |
| App 1 | AppIdentifier1 | APN1 | Tv1 | Tbo1 | BID1, |
| | | | | | BID2, . . . |
| App2 | AppIdentifier2 | APN2 | Tv2 | Tbo2 | BID3, |
| | | | | | BID4, . . . |
| App3 | AppIdentifier3 | APN2 | Tv3 | — | . . . |
| App4 | AppIdentifier1 | APN1 | Tv4 | Tbo1 | . . . |

At a minimum, the table contains the AppIdentifier identifying the application or its type and a Backoff Timer that the UE applies to the application(s) corresponding to the AppIdentifier. TABLE 1 is only an exemplary illustration of information kept by the UE to manage initiation or no initiation of request attempts. It is not suggested that the entry under “Backoff Timer” is a real time value of the running timer. For example, an entry here would indicate there is a backoff. This is updated when the processor running the backoff timer finds that the timer has expired and updates TABLE 1 to indicate that the backoff is no longer there. Alternatively, the entry for “Backoff timer” could be the value provided by the network.

The table may also contain an identifier of the application instance miming in the UE associated with the AppIdentifier identifying the application type. In one example, the identifier of the application running can be an IP packet filter that is used to match IP packets for the data traffic that the application needs to transmit. In another example, the identifier of the application running may be an AppTransactionIT that is associated with an application request for user plane bearers to transport IP data traffic.

The table may also contain the APN associated with the application instance and AppIdentifier. If the identifier of the application instance running in the UE and associated with an AppIdentifier is not present and all the applications associated with an AppIdentifier use the same APN (in case the APN is stored in the table), then for all application instances running in the UE and corresponding to a value of AppIdentifier, only one entry in the table is created.

Further, the table may contain an EntryValidityTimer associated with the AppIdentifier indicating the length of time that application is valid and possibly the identifier of the application running (e.g., this timer can be set when the table entry is created upon the application being launched in the device, and upon EntryValidityTimer expiry, the entry is deleted).

In this example, TABLE 1 has three applications with associated AppIdentifier values. For App1, a BackoffTimer is present. The manner in which the UE may have received such timer and the UE behavior based on this timer are described below. It is noted that all applications associated with a specific AppIdentifier (e.g., App1 and App4 in the example above) are associated with the same value of the BackoffTimer. TABLE 1 may also contain a list of the packet data context identifiers associated with a specific application or an AppIdentifier. Based on the table in the UE, the UE applies the BackoffTimer value to applications. The UE behavior upon applying the BackoffTimer to applications is described below.

Configuration of Backoff Timers in the UE

The BackoffTimer may be provided to the UE dynamically or the BackoffTimer may be configured and/or stored in the UE as described in this section. The BackoffTimer in the UE table can assume one of the Common_AppIdentifier_BackoffTimer or the AppIdentifier_BackoffTimer values described below.

In an embodiment, the UE may have been configured by one of the user, an operator, a service provider, etc. with semi-static values of the Common_AppIdentifier_BackoffTimer or the AppIdentifier_BackoffTimer(s) (i.e., values that are configured or stored in the device and not provided to UE in responses to UE requests to the network for the establishment of user plane resources).

In another embodiment, the UE may have received a Common AppIdentifier BackoffTimer or a list of AppIdentifierBackoffTimer(s) associated with the various AppIdentifier(s) upon attaching to the network, upon PDP context creation, upon PDN connection establishment, upon bearer creation or modification, upon routing area update, or upon tracking area update. If the UE received the timer or timers upon PDP context creation or PDN connection establishment, the UE considers the timers to be applicable specifically to that PDP context and/or PDN connection and/or the APN associated with the PDP Context or PDN Connection and may apply them to request messages corresponding to traffic related to the PDP context(s) or PDN connection(s).

Network-Initiated Resource Control During Congestion

Upon detecting the need to block or restrict the resource usage by one or more applications or services of the UE, the network (e.g., the SGSN or MME) may send status messages (e.g., re-using existing messages or defining new messages) to the UE even if the UE is already in connected mode. The network provides one or more backoff timers associated with one or more AppIdentifier values. Upon receiving such indication, the UE behaves as described above in FIG. 4. These status messages may be at the mobility management (MM) level, the GPRS mobility management (GMM) level, the EPS mobility management (EMM) level, the session management (SM) level, or the EPS session management (ESM) level. The applications the network wishes to restrict the UE from using; or block the UE from using; or require UE to track and report back to network should these applications require user plane resources is conveyed to the UE from the network in a watch list. The UE stores this watch list provided by the network and performs the network requested actions on those applications indicated by the network in this watch list. The applications that the network indicates on the watch list to the UE may be determined from the applications the mobile has previously indicated in signaling messages to the network, or the applications on the watch list can be from the network's own knowledge of applications independent of whether the UE has previously indicated such applications.

Detailed Description of Network Throttling Resources Independent of UE Requests

If the network needs to block some applications that are, for example, causing congestion, even if the UE is already in connected mode, the network sends a signaling message providing one or more backoff timers associated with one or more AppIdentifier(s). Additionally, the network releases the user plane radio bearers related to the application(s) that the network needs to block, unless such user plane radio bearers are in use by another application. The network sends a NAS message to the UE containing a list of AppIdentifiers and timers. Upon receiving a NAS message from the network containing a list of AppIdentifiers and timers, the UE behaves as follows.

If a backoff timer for an AppIdentifier is provided, the application(s) that requested resources and the application(s) corresponding to the AppIdentifier may be informed that a backoff is needed (e.g., indicating no resources available). If a backoff timer is provided, the UE may block transmission of traffic from applications corresponding to the AppIdentifier. If the UE receives backoff timer(s) for one or more AppIdentifier and the user plane radio bearers associated with such AppIdentifier(s) are released, the UE does not release the corresponding EPS bearer contexts. The NAS message used by the network is one or more of ESM STATUS, SM STATUS, ESM INFORMATION REQUEST/RESPONSE. Alternatively, a new message, CONTEXT STATUS UPDATE, may be defined. In a further embodiment, existing NAS messages (GMM/EMM or SM/ESM messages) can be adapted for this purpose.

Indication Through Access Stratum

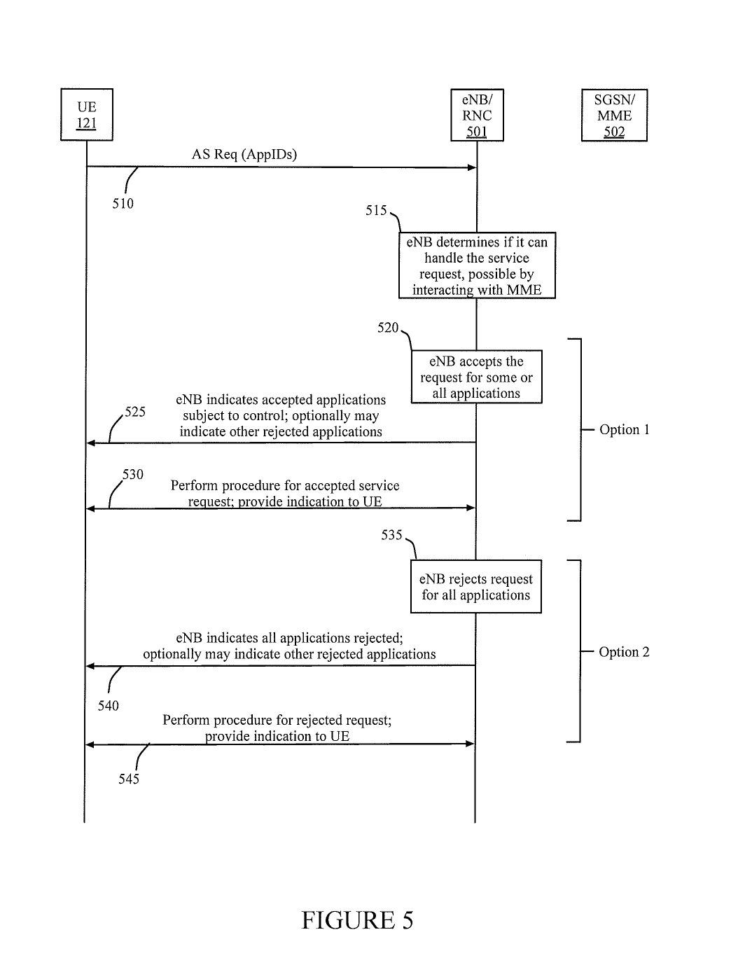

FIG. 5 illustrates service request processing by a radio network controller (RNC) and an associated NodeB (in the case of a UTRAN radio access network) or by an eNodeB (eNB) (in the case of an E-UTRAN radio access network) according to an embodiment of the present disclosure. In FIG. 5, the service request is indicated through the Access Stratum (AS). In such a case, there may be instances in which a UE is in idle mode (i.e., no AS connection), in active mode (i.e., an AS connection is established and resources allocated to it), or in other states (e.g., suspended or dormant, where the UE keep status information on the AS connection but no resources are allocated to the connection).

The present disclosure defines a mechanism wherein the access stratum of the UE 121 sends signaling (e.g., a request) to the network 100 (in this particular embodiment, eNB/RNC 501) containing one or more indications of what applications require user plane bearers, and for which resources are being requested in order to establish an AS connection or refresh, un-suspend, or re-establish an AS connection (510). This embodiment applies, as an example, to a device that is in idle mode and also a device that is in active mode where an AS connection is established and resources allocated to it. This embodiment also applies to a device in other states, such as a suspended or dormant state, or other states that are not active mode, where the UE keep status information on the AS connection but no resources are allocated to the connection. The AS signaling here may be through RRC connection management signaling or radio access bearer (RAB) reconfiguration signaling.

Upon receiving the AS Request from UE 121 (e.g., an RRC CONNECTION REQUEST, RAB reconfiguration request, etc.) containing one or more indications of what applications require user plane bearers, eNB/RNC 501 determines if eNB/RNC 501 can handle the service request (possibly by communicating with MME/SGSN 502) (515).

The network may then perform one of two options. In a first option (Option 1), eNB/RNC 501 accepts the request for resources related to all or some of the applications indicated by the AppIdentifiers from UE 121 (520). Next, eNB/RNC 501 transmits to UE 121 a message indicating to UE 121 which of the accepted applications are subject to control and may further indicate the rejected applications (525). UE 121 and eNB/RNC 501 proceed with procedures for handling the accepted request for service (530).

In a second option (Option 2), eNB/RNC 501 rejects the service request for all applications (535), and transmits an explicit or implicit indication to UE 121 indicating the service request was rejected for all applications and may further indicate other rejected applications (540). eNB/RNC 501 also may include one or more backoff timers to indicate to UE 121 to not attempt further requests for the duration of the timers. Finally, UE 121 and eNB/RNC 501 proceed with procedures for handling the rejected service request (545).

In a further embodiment of the access stratum solution, upon receiving an AS Request from UE 121 (e.g., an RRC CONNECTION REQUEST, RB reconfiguration request, etc.), the network node (e.g., eNB/RNC 501) forwards the request and the indication of applications provided by UE 121 to SGSN/MME 502. Upon receiving such a request or such an indication of applications, the core network (in this particular embodiment, SGSN/MME 502) processes the request as above. The SGSN/MME 502 then returns a rejection or acceptance of the request to the eNB/RNC 501 that in turns provides the rejection or acceptance to UE 121.

Detailed Description of Access Stratum Embodiment

This embodiment augments the establishment cause provided by the UE in an RRC request with an Additional Establishment Cause containing an indication of one or more AppIdentifier(s) for which resources are being requested. Details are provided below to show which AS messages may be modified and in what way.

E-UTRAN

| | RRC messages where the information may be |
|---|---|
| Added information | added |
| A new Additional | RRC Connection Request message-UE to the |
| Establishment Cause | network (eNB) |
| which in turn may contain | RRC Connection Setup Complete message- |
| one or more AppIdentifiers | UE to the network (eNB) |
| for which resources | |
| are being requested. | |
| One or more | RRC Connection Setup-network (eNB) to UE- |
| AppIdentifiers which | in response to an RRC Connection Request |
| the eNB accepts | RRC Connection Reconfiguration-network |
| | (eNB) to UE-used to set up user plane radio |
| | bearers after the RRC Connection is |
| | established and AS security has been started |
| One or more | RRC Connection Reject-network (eNB) to UE- |
| AppIdentifiers which | in response to an RRC Connection Request |
| the eNB rejects | RRC Connection Release-network (eNB) to |
| | UE-sent at any time during the RRC |
| | connection. |

UTRAN

| | RRC messages where the information may |
|---|---|
| Added information | be added |
| An new Additional | RRC Connection Request message-UE to |
| Establishment | the network (RNC) |
| Cause which in turn | RRC Connection Setup Complete message- |
| may contain one | UE to the network (RNC) |
| or more AppIdentifiers | Cell Update message-UE to the network |
| for which resources | (RNC)-sent by a UE when the UE is |
| are being requested. | initially in CELL_PCH or URA_PCH state. |
| One or more | RRC Connection Setup-network (RNC) to |
| AppIdentifiers which | UE-in response to an RRC Connection |
| the eNB accepts or | Request |
| rejects | |
| | Cell Update Confirm-network (RNC) to |
| | UE-in response to a Cell Update |
| | Radio Bearer Setup-network (RNC) to UE |
| One or more | RRC Connection Reject-network (RNC) to |
| AppIdentifiers which | UE-in response to an RRC Connection |
| the eNB rejects | Request |
| | RRC Connection Release-network (RNC) to |
| | UE-sent at any time during the RRC |
| | connection. |

If the network sends one or more AppIdentifiers which the eNB rejects, then the network may include a backoff timer value that specifies the period of time before that application or applications are allowed to attempt to access the network again. The backoff time may be signaled using a new IE or by reusing an existing IE such as the Wait Time IE which already exists in RRC Connection Reject and Cell Update Confirm. This Wait Time IE is currently used for rejecting requests and delaying new RRC connection attempts (i.e., the Wait Time IE is not associated with specific applications) and currently has a maximum time-out of 15 seconds only.

An alternative to sending one or more AppIdentifiers (to or from the network) is to send an Additional Establishment Cause in order to indicate that the request to the network or rejection to the device is for a type or category of service or application. The network may also enclose an Additional Establishment Cause containing more than one AppIdentifier(s), in order to indicate to the device all the applications for which it is requested to backoff.

Piggybacked NAS-AS Embodiment

Instead of using the Service Accept message sent directly from the MME or SGSN to the UE, an indication of acceptance of the service request may be piggybacked onto the AS signaling or encapsulated in AS signaling or concatenated to AS signaling (from the network to the UE) and passed by the AS of the UE to the upper layers (i.e., NAS layer) in the UE. In such an embodiment, the NAS layer of the UE may analyze the new indications from the lower layers before taking any actions, such as locally releasing bearer contexts that do not have allocated user plane bearers, and applying backoff timers if any are indicated. Such indication(s) would be new and would be different from the existing implicit acceptance of Service Request of bearers being allocated by the network and indicated as available by the AS. In particular embodiments, a NAS container in RRC messages (e.g., (3GPP TS 36.331 RRC Connection Reconfiguration Message) may be used to carry such information.

Backoff Indication Passed to UE Higher Layer

In this embodiment, when the UE receives a backoff timer for an AppIdentifier from the network at NAS or AS layers, the UE notifies the higher layers of this event (i.e., that a backoff timer has been received for an AppIdentifier). This notification enables the upper layer to stop sending data for the duration of the timer.

Session Management Signaling

In this embodiment, a UE that is capable of and/or configured to use application-based resource management includes the list of AppIdentifiers for the applications requiring transport resources when requesting new packet data context at session management level (e.g., a new PDN connection or a new PDP context). Upon receiving from the UE a request for new connectivity containing a list of AppIdentifier(s), the network node (e.g., SGSN, MME, GGSN, PDN, GW, etc.) verifies whether new connectivity may be allocated for the corresponding applications (e.g., for which applications access can be granted) or whether the request is to be rejected.

The network then either: 1) if the request can be granted, the network creates the new packet data context (e.g., PDN connectivity request procedure, PDP context activation procedure, etc.), or 2) if the request can be partially granted (i.e., granted only for some applications), the network creates the new connectivity and indicates to the UE via: a) a new information element; b) a code point in an existing information element; or c) in a new message that the request is partially granted/rejected for one or more AppIdentifiers(s), or 3) if the request cannot be satisfied for any of the indicated AppIdentifiers, the network rejects the request.

Upon receiving a message from the network completing (fully or partially) the new connectivity request, the UE may: 1) if the connectivity request was completed successfully without the network (e.g., MME/SGSN) providing a list of indicated applications that are not allowed to use that connection, use that connection for all applications; or 2) if the connectivity request was completed successfully with the network providing a list of indicated applications that are not allowed to use that connection, use that connection for all applications except the identified applications; or 3) if the connectivity request was partly unsuccessfully with the network providing allocated bearer resources and a list of indicated applications that are not allowed to use that connection, use that connection for all applications except the identified applications.

At the time of requesting a new packet data context, the UE may not know which applications will be using, at a later time, the transport resources that are requested. As an example, the UE may have one or a number of applications that have generated uplink data and hence triggered the connectivity request. However, once the packet data context is established other applications might, at some later time, wish to use it. In such a case, if new applications need to use the packet data context (i.e., the applications become part of the active set), the UE may indicate to the network that such application request to use the packet data context (e.g., if the UE has not received any indication from the network that such applications are restricted or forbidden from using the packet data context).

Discovery of Support and Use of Application-Based Resource Management

In this embodiment, the UE indicates to the network the support of application-based resource management in GMM/EMM signaling (e.g., ATTACH ACCEPT message or TRACKING AREA UPDATE ACCEPT message, ROUTING AREA UPDATE ACCEPT message, etc.). The network, upon receiving such indication, stores the indication that the UE supports such feature in the UE context/profile in the SGSN or MME. When performing GMM/EMM signaling (e.g., ATTACH ACCEPT message or TRACKING AREA UPDATE ACCEPT message, ROUTING AREA UPDATE ACCEPT message, etc.), if the UE indicated to the network the support of application-based resource management and if the network supports application-based resource management, then the network may indicate its own support of application-based resource management to the UE.

If the UE receives in GMM/EMM signaling (e.g., ATTACH ACCEPT message or TRACKING AREA UPDATE ACCEPT message ROUTING AREA UPDATE ACCEPT message, etc.) an indication from the network that the network supports use of application-based resource management, then the UE may include in the SERVICE REQUEST or EXTENDED SERVICE REQUEST the list of AppIdentifiers that are related to the pending user traffic.

Grouping of Applications/Rationalizing Multitude of Possible Applications

As is commonly known, for each UE (or even wireless devices without means to provide voice services), there can be hundreds if not thousands of applications. This embodiment discloses that, instead of providing exact indication of applications that are running on the UE or which are subject to control by the NW, indications can instead be in the form of types of applications in terms of their traffic requirements. For instance, such applications groupings can be, but are not limited to: 1) grouped applications as “Real-Time”, “Video/Streaming” or “Background” or the like; 2) profile of maximum tolerable speed that cannot be exceeded; or 3) profile of maximum/minimum bitrate.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method comprising:
receiving in a network node of a wireless network a service request message transmitted by a user equipment, the service request message comprising an application identifier associated with a mobile application executable on the user equipment and a request for network resources to be allocated to the mobile application; and
determining in the network node whether the network is capable of handling the service request based at least partly upon the application identifier; and
in response to the determination, transmitting to the user equipment a response message indicating whether the network node accepts the request for network resources to be allocated to the mobile application.

2. The method as set forth in claim 1, further comprising:
in the network node, generating a watch list comprising at least one mobile application to be monitored by the user equipment; and
transmitting the watch list to the user equipment.

3. The method as set forth in claim 2, wherein the generating a watch list comprises generating the watch list in response to receiving the service request message.

4. The method as set forth in claim 2, wherein the watch list includes a classification for the at least one mobile application and an action to be taken by the user equipment in response to a request for resources from the at least one mobile application.

5. The method set forth in claim 1, further comprising receiving in the network node a first indication message indicating to the network node that the user equipment supports application-based resource management.

6. The method as set forth in claim 5, further comprising, in response to receipt of the first indication message, transmitting a second indication message indicating to the user equipment that the network node supports application-based resource management.

7. For use in a wireless network, a network node configured to:
receive a service request message transmitted by a user equipment, the service request message comprising an application identifier associated with a mobile application executable on the user equipment and a request for network resources to be allocated to the mobile application;
determine whether the network is capable of handling the service request based at least partly upon the application identifier; and
transmit to the user equipment a response message indicating whether the network node accepts the request for network resources to be allocated to the mobile application.

8. The network node as set forth in claim 7, wherein the network node is further configure to:
generate a watch list comprising at least one mobile application to be monitored by the user equipment; and
transmit the watch list to the user equipment.

9. The network node as set forth in claim 8, wherein the network node generates the watch list in response to receiving the service request message.

10. The network node as set forth in claim 8, wherein the watch list includes a classification for the at least one mobile application and an action to be taken by the user equipment in response to a request for resources from the at least one mobile application.

11. The network node set forth in claim 7, wherein the network node is further configured to receive a first indication message indicating to the network node that the user equipment supports application-based resource management.

12. The network node as set forth in claim 5, wherein the network node, in response to receipt of the first indication message, is further configured to transmit a second indication message indicating to the user equipment that the network node supports application-based resource management.

13. A method comprising:
in a user equipment accessing a wireless network, transmitting a service request message to a network node, the service request message comprising an application identifier associated with a mobile application executable on the user equipment and a request for network resources to be allocated to the mobile application; and
receiving a response message indicating whether the network node accepts the request for network resources to be allocated to the mobile application.

14. The method as set forth in claim 13, further comprising:
in the user equipment, receiving a watch list comprising at least one mobile application to be monitored by the user equipment.

15. The method as set forth in claim 14, wherein the receiving a watch list comprises receiving the watch list in response to transmitting the service request message.

16. The method as set forth in claim 14, wherein the watch list includes a classification for the at least one mobile application and an action to be taken by the user equipment in response to a request for resources from the at least one mobile application.

17. The method as set forth in claim 13, transmitting to the network node a first indication message indicating to the network node that the user equipment supports application-based resource management.

18. The method as set forth in claim 17, further comprising receiving from the network node a second indication message indicating to the user equipment that the network node supports application-based resource management.

19. For use in a wireless network, a user equipment configured to:
transmit a service request message to a network node, the service request message comprising an application identifier associated with a mobile application executable on the user equipment and a request for network resources to be allocated to the mobile application; and
receive a response message indicating whether the network node accepts the request for network resources to be allocated to the mobile application.

20. The user equipment as set forth in claim 19, wherein the user equipment is further configured to receive a watch list comprising at least one mobile application to be monitored by the user equipment.

21. The user equipment as set forth in claim 20, wherein the user equipment receives the watch list in response to transmitting the service request message.

22. The user equipment as set forth in claim 20, wherein the watch list includes a classification for the at least one mobile application and an action to be taken by the user equipment in response to a request for resources from the at least one mobile application.

23. The user equipment as set forth in claim 19, wherein the user equipment is further configured to transmit to the network node a first indication message indicating to the network node that the user equipment supports application-based resource management.

24. The user equipment as set forth in claim 23, wherein the user equipment is further configured to receive from the network node a second indication message indicating to the user equipment that the network node supports application-based resource management.
